(19) United States
(12) Patent Application Publication
(10) Pub. No.: US 2002/0069901 A1
(43) Pub. Date: Jun. 13, 2002

(54) Process of cleaning a hard surface

(75) Inventor: Marc Francois Theophile Evers, Strombeek-Bever (BE)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(73) Assignee: The Procter & Gamble Company

(21) Appl. No.: 09/896,277

(22) Filed: Jun. 29, 2001

(30) Foreign Application Priority Data
Jun. 29, 2000 (EP) PCT/EP00/870147.6

(51) Int. Cl. B08B 3/00; C23G 5/00; C02F 5/08; C11D 17/08; C23G 1/00; B08B 3/14; B08B 7/00; C11D 1/00; C03C 23/00; C11D 17/00

(52) U.S. Cl. 134/40; 134/2; 134/36; 134/42; 510/239; 510/248; 510/421; 510/437

(57) ABSTRACT

The present invention relates to a process of cleaning a hard surface with a liquid neutral to alkali composition comprising a polymer and a surfactant system wherein said surfactant system comprises a sulphated or sulphonated anionic surfactant, a neutralizing co-surfactant and an alkoxylated nonionic surfactant.

### FIELD OF THE INVENTION

The present invention relates to a process of cleaning a hard surface with a liquid composition. The liquid hard surface cleaning composition used in the process according to the present invention was found to exhibit a grease removal performance benefit upon contact of the liquid composition on grease, without applying mechanical action.

### BACKGROUND OF THE INVENTION

Liquid compositions for cleaning hard surfaces are well known in the art.

Liquid compositions comprising a surfactant system for grease cleaning have been extensively described in the art, especially in hard surface cleaning application. Examples of liquid compositions known in the art include liquid hard surface detergent compositions comprising a sulphonated anionic surfactant, an amine oxide surfactant and an ethoxylated alcohol surfactant (EP-A-0 080 749), or compositions comprising an alkyl ethoxylated ether sulfate surfactant, a betaine surfactant, an amine oxide surfactant and an ethoxylated alcohol surfactant (WO 98/50508).

However, the grease removal performance of said hard surface cleaning compositions comprising a surfactant system may still be further improved. In particular, the grease removal performance upon contact of the liquid composition on grease, without the need to apply mechanical action may be improved. More particularly, the grease removal performance upon contact of the liquid composition on grease, without applying mechanical action, on inclined or vertical surfaces may be improved.

Thus, the objective of the present invention is to provide a process of cleaning a hard surface with a liquid composition exhibiting a grease removal performance benefit upon contact of the liquid composition on grease, without applying mechanical action.

It has now been found that this objective can be met by a process of cleaning a hard surface with a liquid composition as described herein.

Advantageously, the process as described herein provides a way of cleaning an inclined or vertical hard surface with a liquid composition exhibiting a grease removal performance benefit upon contact of the liquid composition on grease, without applying mechanical action.

A further advantage of the present invention is that the process herein may be used to clean hard surfaces made of a variety of materials like glazed and non-glazed ceramic tiles, enamel, stainless steel, Inox®, Formica®, vinyl, no-wax vinyl, linoleum, melamine, glass, plastics and plastified wood.

Yet a further advantage of the present invention is that the grease removal performance benefit upon contact of the liquid composition on grease, without applying mechanical action, is obtained on greasy stains, as well as on particulate greasy stains and greasy soap scum.

### BACKGROUND ART

EP-A-0 080 749 discloses liquid hard surface detergent compositions comprising a sulphonated anionic surfactant, an amine oxide surfactant and an ethoxylated alcohol surfactant.

WO 98/50508 discloses all-purpose cleaning compositions comprising an alkyl ethoxylated ether sulfate surfactant, a betaine surfactant, an amine oxide surfactant and an ethoxylated alcohol surfactant.

EP-A-0 157 443 discloses detergent compositions comprising a semi-polar nonionic detergent, an anionic surfactant and an acylamidoalkylbetaine.

EP-A-0 595 590 discloses liquid hard surface cleaning compositions comprising an amine oxide surfactant, an alkyl anionic surfactant, an alkoxylated nonionic surfactant and a hydrophobically modified polymer.

### SUMMARY OF THE INVENTION

The present invention relates to a process of cleaning a hard surface with a liquid neutral to alkaline composition comprising a surfactant system, wherein said surfactant system comprises a sulphated or sulphonated anionic surfactant, a neutralising co-surfactant and an alkoxylated nonionic surfactant.

The liquid composition herein further comprises a polymer selected from the group consisting of: a vinylpyrrolidone homopolymer (PVP); a polyethyleneglycol dimethylether (DM-PEG); a vinylpyrrolidone/dialkylaminoalkyl acrylate or methacrylate copolymer; a polystyrenesulphonate polymer (PSS); a poly vinyl pyridine-N-oxide (PVNO); a polyethyleneglycol bis(2-aminopropylether) (DAP-PEG); a polyvinylpyrrolidone/vinylimidazole copolymer (PVP-VI); a cetylhydroxethylcellulose (HM-HEC); a polyvinylpyrrolidone/polyacrylic acid copolymer (PVP-AA); a polyvinylpyrrolidone/vinylacetate copolymer (PVP-VA); a polyacrylic polymer or a poly acrylic-maleic co-polymer; and a polyacrylic or a poly acrylic-maleic co-polymer with a phosphonic end group, and mixtures thereof.

In yet another preferred embodiment according to the present invention said hard surface is an inclined or vertical surface, as for example, mirrors, glass, lavatory pans, urinals, drains or waste pipes.

In still another preferred embodiment according to the present invention said liquid composition is sprayed onto said hard surface.

### DETAILED DESCRIPTION OF THE INVENTION

The Process of Cleaning a Hard Surface

The present invention encompasses a process of cleaning a hard surface with a liquid composition as described herein. In a preferred embodiment said hard surface is contacted with said liquid composition.

By “hard surface”, it is meant herein any kind of surface typically found in houses like kitchens, bathrooms, or in car interiors or exteriors, e.g., floors, walls, tiles, windows, cupboards, sinks, showers, shower plastified curtains, wash basins, WCs, dishes, fixtures and fittings and the like made of different materials like ceramic, vinyl, no-wax vinyl, linoleum, melamine, glass, Inox®, Formica®, any plastics, plastified wood, metal or any painted or varnished or sealed surface and the like. Hard-surfaces also include household appliances including, but not limited to refrigerators, freezers, washing machines, automatic dryers, ovens, microwave ovens, dishwashers and so on.

In a preferred embodiment according to the present invention, the hard surface to be cleaned in the process herein is selected from the group consisting of ceramic, glass, enamel, stainless steel, chromed surfaces and Formica®. Preferably, the hard surface to be cleaned in the process herein is selected from the group consisting of ceramic, glass, enamel, stainless steel and chromed surfaces.

A preferred embodiment of the present invention provides that the liquid composition is applied onto the surface to be treated. The composition may be in its neat form or in its diluted form.

By “diluted form”, it is meant herein that said liquid composition is diluted by the user typically with water. The composition is diluted prior to use to a typical dilution level of 10 to 400 times its weight of water, preferably from 10 to 200 and more preferably from 10 to 100. A usually recommended dilution level is a 1.5% dilution of the composition in water.

By “in its neat form”, it is to be understood that said liquid composition is applied directly onto the surface to be treated without undergoing any dilution, i.e., the liquid composition herein is applied onto the hard surface as described herein.

In a preferred embodiment of the present invention said hard surface is inclined or vertical. Inclined or vertical hard surfaces include mirrors, lavatory pans, urinals, drains, waste pipes and the like.

In another preferred embodiment of the present invention said liquid composition is sprayed onto said hard surface. More preferably, said liquid composition is sprayed in its neat form onto said hard surface.

In another preferred embodiment of the present invention said process of cleaning a hard surface includes the steps of applying, preferably spraying, said liquid composition onto said hard surface, leaving said liquid composition to act onto said surface for a period of time to allow said composition to act, preferably without applying mechanical action, and optionally removing said liquid composition, preferably removing said liquid composition by rinsing said hard surface with water and/or wiping said hard surface with an appropriate instrument, e.g., a sponge, a paper or cloth towel and the like.

In another preferred process of cleaning a hard surface according to the present invention, said composition is applied onto said surface in diluted form without rinsing the hard-surface after application in order to obtain good soil/stain removal performance.

The hard surfaces to be treated may be soiled with a variety of soils, e.g., greasy soils (e.g., greasy soap scum, body grease, kitchen grease or burnt/sticky food residues typically found in a kitchen and the like), particulate greasy soils or so called “limescale-containing stains”. By “limescale-containing stains” it is meant herein any pure limescale stains, i.e., any stains composed essentially of mineral deposits, as well as limescale-containing stains, i.e., stains which contain not only mineral deposits like calcium and/or magnesium carbonate but also soap scum (e.g., calcium stearate) and other grease (e.g. body grease).

Cleaning Performance Test Method

The cleaning performance may be evaluated by the following test methods:

On Horizontal Surfaces:

Kitchen or bath tiles (ceramic, enamel or stainless steel) are prepared by applying to them a representative grease- or grease/particulate-artificial soil followed by ageing (2 hours at 130° C.) of the soiled tiles. The test composition is evaluated by applying a small amount of product (e.g., 5 to 10 ml) directly to the soiled tiles and letting the test composition to act for some time (e.g., up to 1 minute). The test composition is afterwards removed from said tile either by wiping the composition of or rinsing the tile. The cleaning performance is evaluated by measuring the number of cycles needed to get a clean surface versus a reference. The result, i.e., the number of cycles, of the test composition is compared against the result of a reference composition. Alternatively, the cleaning performance may be evaluated either by visually grading the tiles or by using a Colorimeter® Gloss meter. The visual grading may be performed by a group of expert panellists using panel score units (PSU). To asses the cleaning performance benefits of a given composition a PSU-scale ranging from 0, meaning no noticeable difference in cleaning performance versus a reference composition, to 4, meaning a noticeable difference in cleaning performance versus a reference composition, can be applied.

On Vertical Surfaces (for Spray Products Only):

A fine layer (20 grams/m²) of a mixture (ratio 75/25 (w/w) grease/particulate soil) of grease and particulate artificial soil is applied to kitchen or bath tiles (ceramic, enamel, Formica®) or stainless steel). A small amount of the cleaning composition (e.g., 2 grams) is sprayed onto the soiled vertically positioned surface. Optionally, a rinsing step can be performed wherein the tiles are treated with water. The cleaning performance is evaluated either by visually grading the tiles or by using a Colorimeter® Gloss meter. The visual grading may be performed by a group of expert panellists using panel score units (PSU). To asses the cleaning performance benefits of a given composition a PSU-scale ranging from 0, meaning no noticeable difference in cleaning performance versus a reference composition, to 4, meaning a noticeable difference in cleaning performance versus a reference composition, can be applied.

Liquid Composition

The composition of the present invention is formulated as a liquid composition.

Preferred compositions of the present invention have a viscosity of 1 cps or greater, more preferably of from 1 to 5000 cps, and still more preferably of from 1 to 500 cps at 20° C. when measured with a CSL² 100® Rheometer at 20° C. with a 4 cm spindle (linear increment from 10 to 100 dyne/cm² in 2 minutes).

A preferred composition herein is an aqueous composition and therefore, preferably comprises water more preferably in an amount of from 50% to 98%, even more preferably of from 75% to 97% and most preferably 80% to 97% by weight of the total composition.

The pH range is from 7 to 14, preferably from 7.1 to 14, more preferably from 7.1 to 13, even more preferably from 7.1 to 12 and most preferably from 8.0 to 10. Indeed, it has been surprisingly found that the greasy cleaning performance is further improved at these preferred alkaline to neutral pH ranges, preferably alkaline pH ranges. Accordingly, the compositions herein may further comprise an acid or base to adjust pH as appropriate.

A suitable acid for use herein is an organic and/or an inorganic acid. A preferred organic acid for use herein has a pka of less than 6. A suitable organic acid is selected from the group consisting of citric acid, lactic acid, glycolic acid, succinic acid, glutaric acid and adipic acid and a mixture thereof. A mixture of said acids may be commercially available from BASF under the trade name Sokalan® DCS. A suitable inorganic acid is selected from the group consisting hydrochloric acid, sulphuric acid, phosphoric acid and a mixture thereof.

A typical level of such an acid, when present, is of from 0.01% to 5.0%, preferably from 0.04% to 3.0% and more preferably from 0.05% to 1.5% by weight of the total composition.

A suitable base to be used herein is an organic and/or inorganic base. Suitable bases for use herein are the caustic alkalis, such as sodium hydroxide, potassium hydroxide and/or lithium hydroxide, and/or the alkali metal oxides such, as sodium and/or potassium oxide or mixtures thereof. A preferred base is a caustic alkali, more preferably sodium hydroxide and/or potassium hydroxide.

Other suitable bases include ammonia, ammonium carbonate, K₂CO₃, Na₂CO₃ and alkanolamines (as e.g. monoethanolamine).

Typical levels of such bases, when present, are of from 0.01% to 5.0%, preferably from 0.05% to 3.0% and more preferably from 0.1% to 0.6% by weight of the total composition.

Surfactant System

As outlined above, the cleaning composition used in a process as described herein comprises a specific surfactant system as described herein, preferably wherein said surfactant system has a σ_{L/O} (interfacial tension of the surfactant system-containing composition to the greasy soil) of less than 4 mN/m measured at a 0.15% total surfactant concentration in deionized water at 25° C.; and a σ_{L/S} (interfacial tension of the surfactant system-containing composition to the hard surface) that is lower than the interfacial tension of the greasy soil to be removed to the hard surface to be cleaned (σ_{O/S}).

By “interfacial tension” it is meant herein, the tension measured between the two phases of substantially non-mixable liquid compositions or between a liquid composition and a solid surface.

By “the interfacial tension of the surfactant system-containing composition to the greasy soil (σ_{L/O})” it is meant herein, the interfacial tension between the surfactant system-containing composition and the greasy soil, measured at a 0.15% total surfactant concentration in deionized water at 25° C. For instance, the σ_{L/O} can be measured using a Drop volume tensiometer, for example a Lauda TVT-1®. This method is especially useful when measuring dynamic interfacial tensions, as for example the interfacial tension of the surfactant system-containing composition to the greasy soil (σ_{L/O}). To measure the interfacial tension between the oil and a surfactant containing composition using a drop volume tensiometer, a droplet of one of the two phases, for instance the greasy soil phase or the surfactant system-containing composition phase, is formed into the second phase of the two phases, for instance the surfactant system-containing composition herein or the greasy soil phase respectively, at the tip of a capillary. At the moment just before the droplet detaches from the tip, an equilibrium between the separation force and the adherence force at the tip due to the interfacial tension, is established. The Drop Volume Tensiometer measures the Volume (V_{drop}) of each droplet by adjusting the flow of the liquid through the tip (dV/dt) and measuring the time (surface age) from V=0 ml to the moment when said droplet detaches from the tip (dt). The (dynamic) Interfacial Tension σ_{L/O} is linear to the volume of the drop formed:

σ_{L/O}=V_{drop}×(Δdensity)×g/(π×d)

wherein Δdensity is the difference in density of the two phases as measured with a densitymeter, g is the gravitation constant and d is the diameter of the tip.

Preferably, said surfactant system has a σ_{L/O} (interfacial tension of the surfactant system-containing composition to the greasy soil) of less than 2 mN/m, more preferably less than 1 mN/m measured at a 0.15% total surfactant concentration in deionized water at 25° C.

By “the interfacial tension of the surfactant system-containing composition to the hard surface (σ_{L/O})” it is meant herein, the interfacial tension between the surfactant system and the hard surface to be cleaned. Preferably, the interfacial tension of the surfactant system-containing composition to the hard surface (σ_{L/O}) is also assessed at a 0.15% total surfactant concentration in deionized water at 25° C. The σ_{L/S} can be calculated using results of contact angle measurements, for example using a Kruss DSA 10® Drop Shape Analysis System. The Drop Shape Analysis System measures the contact angle θ of a liquid on a surface, wherein the higher said contact angle is, the poorer is the interaction of the liquid with the surface, this means the worse is the wetting of the liquid on the surface. During the measurement the surface tension σ_{L/A} (interfacial tension of the tested liquid to air) has to be assessed. In turn, with the contact angle θ, the σ_{L/A} and the interfacial tension of a given hard surface to air interfacial tension (σ_{S/A}), on the given hard surface, having a measured or known surface free energy (which is the basis for the calculation of the σ_{S/A} interfacial tension), the interfacial tension of the surfactant system-containing composition to the hard surface (σ_{L/S}) can be calculated using the Young's equation

σ_{L/A}×cos θ=σ_{S/A}−σ_{L/S}.

By “interfacial tension of the greasy soil to the hard surface (σ_{O/S})” it is meant herein, the interfacial tension between the greasy soil and the hard surface to be cleaned. The interfacial tension of the greasy soil to the hard surface strongly depends on the type of greasy soil to be found on the hard surface. The σ_{O/S} can be measured with contact angle measurements, for example using a Kruss DSA 10® Drop Shape Analysis System, as described above.

The three interfacial tensions described herein are dependent on the physical and/or chemical properties of the surfactant system used, the hard surface to be cleaned and the greasy soil on said surface. However, the physical and/or chemical properties of hard surfaces and the greasy soils depend on the type of hard surface to be cleaned and the type of greasy soil found on said hard surface. Therefore, it is essential for the present invention to choose a suitable surfactant system, providing the interfacial tensions σ_{L/O} and σ_{L/S} as described herein above. Indeed, to provide a cleaning composition having the specific σ_{L/O} (interfacial tension of the surfactant system-containing composition to the greasy soil) and the σ_{L/S} (interfacial tension of the surfactant system-containing composition to the hard surface) interfacial tensions any surfactant system known to those skilled in the art providing said specific σ_{L/O} and σ_{L/S} interfacial tensions may be used.

The surfactant system herein consists of a sulphated or sulphonated anionic surfactant, a neutralising co-surfactant and an alkoxylated nonionic surfactant.

Sulphated or Sulphonated Anionic Surfactant

The surfactant system according to the present invention comprises a sulphated or sulphonated anionic surfactant or a mixture thereof.

Suitable sulphated anionic surfactants for use herein are all those commonly known by those skilled in the art. Preferably, the sulphated anionic surfactants for use herein are selected from the group consisting of: alkyl sulphates; and alkoxylated sulphates; and mixtures thereof.

Suitable alkyl sulphates for use herein include water-soluble salts or acids of the formula ROSO₃M wherein R is a C₆-C₂₀ linear or branched, saturated or unsaturated alkyl group, preferably a C₈-C₁₈ alkyl group and more preferably a C₁₀-C₁₄ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Particularly suitable linear alkyl sulphates include C_{12,14} Alkyl Sulphate like EMPICOL® 0298/, EMPICOL® 0298/F or EMPICOL® XLB commercially available from ALBRIGHT & WILSON.

By “linear alkyl sulphate” it is meant herein a non-substituted alkyl sulphate wherein the alkyl chain comprises from 6 to 20 carbon atoms, preferably from 8 to 18 carbon atoms, and more preferably from 10 to 14 carbon atoms, and wherein this alkyl chain is sulphated at one terminus.

Suitable alkoxylated sulphate surfactants for use herein are according to the formula RO(A)ₘSO₃M wherein R is an unsubstituted C₆-C₂₀ alkyl, hydroxyalkyl or alkyl aryl group, having a linear or branched C₆-C₂₀ alkyl component, preferably a C₁₂-C₂₀ alkyl or hydroxyalkyl, more preferably C₁₂-C₁₈ alkyl or hydroxyalkyl, A is an ethoxy or propoxy or butoxy unit or a mixture thereof, m is greater than zero, typically between 0.5 and 6, more preferably between 0.5 and 3, and M is H or a cation which can be, for example, a metal cation (e.g., sodium, potassium, lithium, calcium, magnesium, etc.), ammonium or substituted-ammonium cation. Alkyl ethoxylated sulphates, alkyl butoxylated sulphates as well as alkyl propoxylated sulphates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines such as ethylamine, diethylamine, triethylamine, mixtures thereof, and the like. Exemplary surfactants are C₁₂-C₁₈ alkyl polyethoxylate (1.0) sulphate (C₁₂-C₁₈E(1.0)SM), C₁₂-C₁₈ alkyl polyethoxylate (2.25) sulphate (C₁₂-C₁₈E(2.25)SM), C₁₂-C₁₈ alkyl polyethoxylate (3.0) sulphate (C₁₂-C₁₈E(3.0)SM), and C₁₂-C₁₈ alkyl polyethoxylate (4.0) sulphate (C₁₂-C₁₈E(4.0)SM), wherein M is conveniently selected from sodium and potassium. Particularly suitable alkoxylated sulphates include ELFAN® NS 243S commercially available from AKZO, EMPICOL® ESC 3 from Albright&Wilson, Serdet® DNK30 (3EO) commercially available from SERVO or Rewopol® NOS 5 commercially available from Rewo.

Suitable sulphonated anionic surfactants for use herein are all those commonly known by those skilled in the art. Preferably, the sulphonated anionic surfactants for use herein are selected from the group consisting of: alkyl sulphonates; alkyl aryl sulphonates; naphthalene sulphonates; alkyl alkoxylated sulphonates; and C₆-C₂₀ alkyl alkoxylated linear or branched diphenyl oxide disulphonates; and mixtures thereof.

Suitable alkyl sulphonates for use herein include water-soluble salts or acids of the formula RSO₃M wherein R is a C₆-C₂₀ linear or branched, saturated or unsaturated alkyl group, preferably a C₈-C₁₈ alkyl group and more preferably a C₁₄-C₁₇ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Suitable alkyl aryl sulphonates for use herein include water-soluble salts or acids of the formula RSO₃M wherein R is an aryl, preferably a benzyl, substituted by a C₆-C₂₀ linear or branched saturated or unsaturated alkyl group, preferably a C₈-C₁₈ alkyl group and more preferably a C₈-C₁₄ alkyl group, and M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Particularly suitable linear alkyl sulphonates include C₁₄-C₁₇ paraffin sulphonate like Hostapur ® SAS commercially available from Hoechst. An example of commercially available alkyl aryl sulphonate is Lauryl aryl sulphonate from Su.Ma. Particularly preferred alkyl aryl sulphonates are alkyl benzene sulphonates commercially available under trade name Nansa® available from Albright&Wilson.

By “linear alkyl sulphonate” it is meant herein a non-substituted alkyl sulphonate wherein the alkyl chain comprises from 6 to 20 carbon atoms, preferably from 8 to 18 carbon atoms, and more preferably from 14 to 17 carbon atoms, and wherein this alkyl chain is sulphonated at one terminus.

Suitable alkoxylated sulphonate surfactants for use herein are according to the formula R(A)ₘSO₃M wherein R is an unsubstituted C₆-C₂₀ alkyl, hydroxyalkyl or alkyl aryl group, having a linear or branched C₆-C₂₀ alkyl component, preferably a C₁₂-C₂₀ alkyl or hydroxyalkyl, more preferably C₁₂-C₁₈ alkyl or hydroxyalkyl, A is an ethoxy or propoxy or butoxy unit, m is greater than zero, typically between 0.5 and 6, more preferably between 0.5 and 3, and M is H or a cation which can be, for example, a metal cation (e.g., sodium, potassium, lithium, calcium, magnesium, etc.), ammonium or substituted-ammonium cation. Alkyl ethoxylated sulphonates, alkyl butoxylated sulphonates as well as alkyl propoxylated sulphonates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines such as ethylamine, diethylamine, triethylamine, mixtures thereof, and the like. Exemplary surfactants are C₁₂-C₁₈ alkyl polyethoxylate (1.0) sulphonate (C₁₂-C₁₈E(1.0)SM), C₁₂-C₁₈ alkyl polyethoxylate (2.25) sulphonate (C₁₂-C₁₈E(2.25)SM), C₁₂-C₁₈ alkyl polyethoxylate (3.0) sulphonate (C₁₂-C₁₈E(3.0)SM), and C₁₂-C₁₈ alkyl polyethoxylate (4.0) sulphonate (C₁₂-C₁₈E(4.0)SM), wherein M is conveniently selected from sodium and potassium. Particularly suitable alkoxylated sulphonates include alkyl aryl polyether sulphonates like Triton X-200® commercially available from Union Carbide.

Suitable C₆-C₂₀ alkyl alkoxylated linear or branched diphenyl oxide disulphonate surfactants for use herein are according to the following formula:

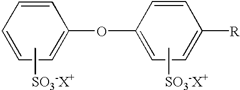

wherein R is a C₆-C₂₀ linear or branched, saturated or unsaturated alkyl group, preferably a C₆-C₁₈ alkyl group and more preferably a C₆-C₁₄ alkyl group, and X+ is H or a cation, e.g., an alkali metal cation (e.g., sodium, potassium, lithium, calcium, magnesium and the like). Particularly suitable C₆-C₂₀ alkyl alkoxylated linear or branched diphenyl oxide disulphonate surfactants to be used herein are the C₁₂ branched di phenyl oxide disulphonic acid and C₁₆ linear di phenyl oxide disulphonate sodium salt respectively commercially available by DOW under the trade name Dowfax 2A1® and Dowfax 8390®.

Preferably said sulphated or sulphonated anionic surfactant for use herein is selected from the group consisting of: alkyl sulphates; alkyl alkoxylated sulphates; alkyl sulphonates; alkyl aryl sulphonates; alkyl alkoxylated sulphonates; C₆-C₂₀ alkyl alkoxylated linear or branched diphenyl oxide disulphonates; naphthalene sulphonates; and mixtures thereof. More preferably said sulphated or sulphonated anionic surfactant for use herein is selected from the group consisting of: alkyl sulphonates; alkyl sulphates; alkyl alkoxylated sulphates; alkyl aryl sulphonates; and mixtures thereof. Even more preferably said sulphated or sulphonated anionic surfactant for use herein is paraffin sulphonate. Most preferably said sulphonated anionic surfactant for use herein is a C₁₄-C₁₇ paraffin sulphonate.

Typically, the liquid composition herein may comprise from 0.005% to 20%, preferably from 0.1% to 10%, more preferably from 0.1% to 5.0% and most preferably from 0.2% to 3.0% by weight of the total composition of said sulphated or sulphonated anionic surfactant.

Neutralising Co-surfactant

The surfactant system according to the present invention preferably comprises a neutralising co-surfactant. Preferably, said neutralising co-surfactant at least partially neutralises the negative charges of said sulphated or sulphonated anionic surfactant.

Preferably, said neutralising co-surfactant is uncharged or comprises positive and negative charges within the same molecule. More preferably, said neutralising co-surfactant is an (overall) uncharged polar surfactant (with a strong dipole moment) or comprises positive and negative charges within the same molecule. Even more preferably, said neutralising co-surfactant is an uncharged polar surfactant or comprises the same amount of positive and negative charges within the same molecule. Most preferably, said neutralising co-surfactant is not a cationic surfactant.

Any neutralising co-surfactant having the desired property of at least partially neutralising the negative charges of said sulphated or sulphonated anionic surfactant may be used.

Preferred neutralising co-surfactants are selected from the group consisting of amine oxide surfactants; betaine surfactants; and sulfobetaine surfactants; and mixtures thereof.

Suitable betaine or sulfobetaine surfactants are according to the formulae:

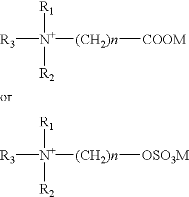

wherein: R₁ and R₂ are each independently linear or branched, saturated or unsaturated hydrocarbon chains of from 1 to 30, preferably 1 to 20, more preferably 1 to 7, carbon atoms; R₃ is a linear or branched hydrocarbon chain of from 8 to 30, preferably of from 10 to 20, more preferably 12 to 18 carbon atoms; n is an integer of from 1 to 20, preferably 1 to 10, more preferably 1 to 5; and M is H or an alkali metal, or mixtures thereof.

Examples of suitable betaine or sulfobetaine surfactants include coconut-dimethyl betaine commercially available from Albright & Wilson. A suitable sulfobetaine is commercially available from WITCO (Rewoteric AM-CAS®).

Suitable amine oxide surfactants are according to the formula: R₁ R₂R₃NO wherein each of R₁, R₂ and R₃ is independently a saturated or unsaturated, substituted or unsubstituted, linear or branched hydrocarbon chains of from 1 to 30 carbon atoms. Preferred amine oxide surfactants to be used according to the present invention are amine oxides having the following formula: R₁R₂R₃NO wherein R₁ is an hydrocarbon chain comprising from 1 to 30 carbon atoms, preferably from 6 to 20, more preferably from 8 to 16, most preferably from 8 to 12; and wherein R₂ and R₃ are independently saturated or unsaturated, substituted or unsubstituted, linear or branched hydrocarbon chains comprising from 1 to 4 carbon atoms, preferably from 1 to 3 carbon atoms, and more preferably are methyl groups. R₁ may be a saturated or unsaturated, substituted or unsubstituted linear or branched hydrocarbon chain. Suitable amine oxides for use herein are for instance natural blend C₈-C₁₀ amine oxides as well as C₁₂-C₁₆ amine oxides commercially available from Hoechst, preferred amine oxide is C₁₂-C₁₄ dimethyl amine oxide commercially available from Albright & Wilson, C₁₂-C₁₄ amine oxides commercially available under the trade name Genaminox® LA from Hoechst or AROMOX® DMMCD-W from AKZO or C₁₄ amine oxides commercially available under the trade name AROMOX® DM14D-W970 (—AO) from AKZO.

Preferably, said neutralising co-surfactant is selected from the group consisting of: amine oxide surfactants; betaine surfactants; and sulfobetaine surfactants; and mixtures thereof. More preferably, said neutralising co-surfactant is selected from the group consisting of: amine oxide surfactants; and betaine surfactants; and mixtures thereof. Even more preferably, said neutralising co-surfactant is an amine oxide surfactant.

Typically, the liquid composition herein may comprise from 0.005% to 30%, preferably from 0.1% to 15.0%, more preferably from 0.1% to 10% and most preferably from 0.20% to 5.0% by weight of the total composition of said neutralising co-surfactant.

Alkoxylated Nonionic Surfactant

The surfactant system according to the present invention further comprises an alkoxylated nonionic surfactant. Suitable alkoxylated nonionic surfactants herein include non-capped or capped alkoxylated nonionic surfactants and mixtures thereof.

Suitable non-capped alkoxylated nonionic surfactants are according to the formula RO—(A)ₙH, wherein: R is a C₆ to C₂₂, preferably a C₈ to C₂₂, more preferably a C₉ to C₁₄ alkyl chain, or a C₆ to C₂₈ alkyl benzene chain; A is an ethoxy or propoxy or butoxy unit or a mixture thereof; and wherein n is from 0 to 20, preferably from 1 to 15 and, more preferably from 2 to 15 even more preferably from 2 to 12 and most preferably from 4 to 10. Preferred R chains for use herein are the C₈ to C₂₂ alkyl chains. Even more preferred R chains for use herein are the C₉ to C₁₂ alkyl chains. Non-capped ethoxy/butoxylated, ethoxy/propoxylated, butoxy/propoxylated and ethoxy/butoxy/propoxylated nonionic surfactants may also be used herein. Preferred non-capped alkoxylated nonionic surfactants are non-capped ethoxylated nonionic surfactants.

Suitable non-capped ethoxylated nonionic surfactants for use herein are Dobanol® 91-2.5 (HLB=8.1; R is a mixture of C₉ and C₁₁ alkyl chains, n is 2.5), or Lutensol® TO3 (HLB=8; R is a C₁₃ alkyl chains, n is 3), or Lutensol® AO3 (HLB=8; R is a mixture of C₁₃ and C₁₅ alkyl chains, n is 3), or Tergitol® 25L3 (HLB=7.7; R is in the range Of C₁₂ to C₁₅ alkyl chain length, n is 3), or Dobanol® 23-3 (HLB=8.1; R is a mixture of C12 and C13 alkyl chains, n is 3), or Dobanol® 23-2 (HLB=6.2; R is a mixture of C₁₂ and C₁₃ alkyl chains, n is 2), or Dobanol® 45-7 (HLB=11.6; R is a mixture of C₁₄ and C15 alkyl chains, n is 7) Dobanol® 23-6.5 (HLB=11.9; R is a mixture of C₁₂ and C₁₃ alkyl chains, n is 6.5), or Dobanol® 25-7 (HLB=12; R is a mixture of C₁₂ and C₁₅ alkyl chains, n is 7), or Dobanol® 91-5 (HLB=11.6; R is a mixture of C₉ and C₁₁ alkyl chains, n is 5), or Dobanol® 91-6 (HLB=12.5; R is a mixture of C₉ and C₁₁ alkyl chains, n is 6), or Dobanol® 91-8 (HLB=13.7; R is a mixture of C₉ and C₁₁ alkyl chains, n is 8), Dobanol® 91-10 (HLB=14.2; R is a mixture of C₉ to C₁₁ alkyl chains, n is 10), Dobanol® 91-12 (HLB=14.5; R is a mixture of C₉ to C₁₁ alkyl chains, n is 12), Lialethl® 11-5 (R is a C₁₁ alkyl chain, n is 5), Isalchem® 11-5 (R is a mixture of linear and branched C₁₁ alkyl chain, n is 5), Lialethl® 11-21 (R is a mixture of linear and branched C₁₁ alkyl chain, n is 21), Isalchem® 11-21 (R is a C₁₁ branched alkyl chain, n is 21), Empilan® KBE21 (R is a mixture of C₁₂ and C₁₄ alkyl chains, n is 21) or mixtures thereof. Preferred herein are Lutensol® TO3, or Lutensol® AO3, or Tergitol® 25L3, or Dobanol® 23-3, or Dobanol® 23-6.5, or Dobanol® 45-7, Dobanol® 91-5 , Neodol® 11-5, Lialethl® 11-21 Lialethl® 11-5 Isalchem® 11-5 Isalchem® 11-21 Dobanol® 91-8, or Dobanol® 91-10, or Dobanol® 91-12, or mixtures thereof. These Dobanol®Neodol® surfactants are commercially available from SHELL. These Lutensol® surfactants are commercially available from BASF and these Tergitol® surfactants are commercially available from UNION CARBIDE.

Suitable capped alkoxylated non-ionic surfactants, having the terminal hydroxyl group capped, are according to the formula: R(A)n-O—R1 where R and R1 are independently a C₁ to C₃₀, preferably a C₁ to C₂₀ alkyl chain, or a C₁ to C₁₈ alkyl benzene chain; A is an ethoxy or propoxy or butoxy unit or a mixture thereof; n is from 0 to 20, preferably from 1 to 15 and, more preferably from 2 to 15 and most preferably from 2 to 12. Capped ethoxy/butoxylated, ethoxy/propoxylated, butoxy/propoxylated and ethoxy/butoxy/propoxylated nonionic surfactants may also be used herein. A suitable capped alkoxylated non-ionic surfactants for use herein is for instance Plurafac® LF231 commercially available from BASF.

Suitable chemical processes for preparing the alkoxylated nonionic surfactants for use herein include condensation of corresponding alcohols with alkylene oxide, in the desired proportions. Such processes are well known to the person skilled in the art and have been extensively described in the art.

Preferably, said alkoxylated nonionic surfactant is selected from the group consisting of: non-capped alkoxylated nonionic surfactants; and capped alkoxylated nonionic surfactants; and mixtures thereof. More preferably, said alkoxylated nonionic surfactant is a C9-12 EO 4-10 alkylethoxylate, a C9-12 EO 4-7 alkylethoxylate or a C9-14 EO 12-30 alkylethoxylate or a mixture thereof. Most preferably, said alkoxylated nonionic surfactant is a C11 EO5 alkylethoxylate or a C11 EO 21 alkylethoxylate or a mixture thereof.

Typically, the liquid composition herein may comprise from 0.005% to 30%, preferably from 0.1% to 20%, more preferably from 0.1% to 15% and most preferably from 0.3% to 8% by weight of the total composition of said alkoxylated nonionic surfactant.

The present invention is based on the finding that the process of treating a hard surface with a liquid composition comprising a surfactant system as described herein exhibits excellent grease removal. Indeed, the Applicant has found that the combination in a liquid composition of a surfactant system wherein said surfactant system at a 0.15% total surfactant concentration in deionized water at 25° C. has preferably a σ_{L/O} (interfacial tension of the surfactant system-containing composition to the greasy soil) of less than 4 mN/m and a σ_{L/S} (interfacial tension of the surfactant system-containing composition to the hard surface) that is lower than the interfacial tension of the greasy soil to be removed to the hard surface to be cleaned (σ_{O/S}) and consists of a sulphated or sulphonated anionic surfactant, a neutralising co-surfactant and an alkoxylated nonionic surfactant, provides a grease removal performance benefit upon contact of said liquid composition on grease, without applying mechanical action.

Although not wishing to be bound by theory, the Applicant has surprisingly found that not only the interfacial tension between the cleaning composition and the greasy soil (represented herein by the σ_{L/O}-interfacial tension of the surfactant system-containing composition to the greasy soil) is of high relevance for the greasy soil removal performance of a hard surface cleaning composition but also the interfacial tension between the cleaning composition and the hard surface to be cleaned (represented herein by the σ_{L/S}-interfacial tension of the surfactant system-containing composition to the hard surface). Preferably, both the σ_{L/S}-interfacial tension of the surfactant system-containing composition to the greasy soil and the σ_{L/S}-interfacial tension of the surfactant system-containing composition to the hard surface have to be low and in addition the σ_{L/S}-interfacial tension of the surfactant system-containing composition to the hard surface has to be lower than the interfacial tension of the greasy soil to be removed to the hard surface to be cleaned (σ_{O/S}) Indeed, it has been found that a surfactant system providing the interfacial tensions required herein when used in a hard surface cleaning composition to clean a hard surface soiled by greasy soil, will detach the greasy soil from the hard surface, fragment the greasy soil into small oil droplets and keep those droplets in suspension (redeposition prevention). The low σ_{L/S} of the cleaning composition, which is lower than the σ_{O/S}, is believed to be responsible for the good detachment of the greasy soil from the hard surface and the fragmentation of the greasy soil into small oil droplets (“grease removal performance benefit”). The low σ_{L/O} of the cleaning composition, this means a σ_{L/O} of less than 4 mN/m, preferably less than 2 mN/m, more preferably less than 1 mN/m, is believed to be responsible for keeping the oily droplets in suspension and therefore preventing the redeposition of these droplets onto the surface (“grease redeposition prevention benefit”). This grease removal performance benefit and grease redeposition prevention benefit allows to formulate liquid hard surface cleaning compositions that do not require the application of mechanical cleaning-action to remove grease from a surface after said liquid composition is applied onto said surface (“grease removal performance benefit upon contact of said liquid composition on grease, without applying mechanical action”).

It is speculated that in the highly preferred embodiments herein where the surfactant system consists of a combination of a sulphated of sulphonated anionic surfactant with a neutralising co-surfactant as described above, the low σ_{L/S} and low σ_{L/O} of the cleaning composition are achieved by the neutralising co-surfactant that neutralises the negative charges of the anionic surfactant and thus lowers the electrostatic and steric repulsive forces between the anionic surfactant molecules. Thus, the local surfactant concentration of the anionic surfactant at the cleaning composition/greasy soil interface or the cleaning composition/hard surface interface is increased as the surfactant molecules are grouped closer together. By increasing said local surfactant concentration at the two interfaces, said anionic surfactant can act better on the grease and thus provides an improved grease removal and redeposition prevention performance.

Furthermore, the relatively expensive neutralising co-surfactant may be partially replaced with a cheaper alkoxylated nonionic surfactant without negatively influencing the grease removal performance benefit. Thereby, the production costs of the liquid hard surface cleaning composition used in the process according to the present invention are lowered. In addition, alkoxylated nonionic surfactants at the right HLB (hydrophilic-lipophilic balance) may further lower the steric repulsion of the anionic-neutralising co-surfactant system.

Polymer

The compositions used in the process according to the present invention comprise a polymer selected from the group consisting of: a vinylpyrrolidone homopolymer (PVP); a polyethyleneglycol dimethylether (DM-PEG); a vinylpyrrolidone/dialkylaminoalkyl acrylate or methacrylate copolymers; a polystyrenesulphonate polymer (PSS); a poly vinyl pyridine-N-oxide (PVNO); a polyethyleneglycol bis(2-aminopropylether) (DAP-PEG); a polyvinylpyrrolidone/vinylimidazole copolymer (PVP-VI); a cetylhydroxethylcellulose (HM-HEC); a polyvinylpyrrolidone/polyacrylic acid copolymer (PVP-AA); a polyvinylpyrrolidone/vinylacetate copolymer (PVP-VA); a polyacrylic polymer or polyacrylic-maleic copolymer; and a polyacrylic or polyacrylic-maleic phosphono end group copolymer; and mixtures thereof.

Suitable vinylpyrrolidone homopolymers (PVP) for use herein are homopolymers of N-vinylpyrrolidone having the following repeating monomer:

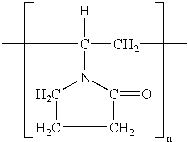

wherein n (degree of polymerisation) is an integer of from 10 to 1,000,000, preferably from 20 to 100,000, and more preferably from 20 to 10,000.

Suitable, vinylpyrrolidone homopolymers (“PVP”) for use herein have an average molecular weight of from 1,000 to 100,000,000, preferably from 2,000 to 10,000,000, more preferably from 5,000 to 1,000,000, and most preferably from 50,000 to 500,000.

Suitable vinylpyrrolidone homopolymers are commercially available from ISP Corporation, New York, N.Y. and Montreal, Canada under the product names PVP K-15® (viscosity molecular weight of 10,000), PVP K-30® (average molecular weight of 40,000), PVP K-60® (average molecular weight of 160,000), and PVP K-90® (average molecular weight of 360,000). Other suitable vinylpyrrolidone homopolymers which are commercially available from BASF Co-operation include Sokalan HP 165®, Sokalan HP 12®, Luviskol K30®, Luviskol K60®, Luviskol K80®, Luviskol K90® and other vinylpyrrolidone homopolymers known to persons skilled in the detergent field (see for example EP-A-262,897 and EP-A-256,696).

Suitable polyethyleneglycol dimethylethers (DM-PEG) for use herein are according to the formula:

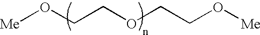

wherein n is an integer greater than 0.

Preferably n is an integer greater than 1, more preferably from 5 to 1000, even more preferably from 10 to 100, yet even more preferably from 20 to 60 and most preferably from 30 to 50. A preferred polyethyleneglycol dimethylether herein is dimethyl polyethylene glycol having a molecular weight of 2000.

Suitable polyethyleneglycol dimethylethers (DM-PEG) are commercially available from Hoechst as the polyglycol series, e.g., PEG-DME-2000®.

Suitable vinylpyrrolidone/dialkylaminoalkyl acrylate or methacrylate copolymers (quaternised or unquaternised) suitable for use in the compositions of the present invention are according to the following formula:

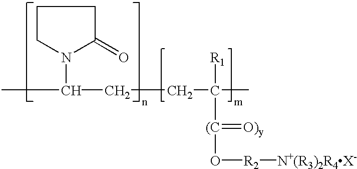

in which n is between 20 and 99 and preferably between 40 and 90 mol % and m is between 1 and 80 and preferably between 5 and 40 mol %; R₁ represents H or CH₃; y denotes 0 or 1; R₂ is —CH₂—CHOH—CH₂— or CₓH₂ₓ, in which x=2 to 18; R₃ represents a lower alkyl group of from 1 to 4 carbon atoms, preferably methyl or ethyl, or

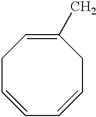

R₄ denotes a lower alkyl group of from 1 to 4 carbon atoms, preferably methyl or ethyl; X⁻ is chosen from the group consisting of Cl, Br, I, ½ SO₄, HSO₄ and CH₃SO₃. The polymers can be prepared by the process described in French Pat. Nos. 2,077,143 and 2,393,573.

The preferred quaternized or unquaternized vinylpyrrolidone/dialkylaminoalkyl acrylate or methacrylate copolymers for use herein have a molecular weight of between 1,000 and 1,000,000, preferably between 10,000 and 500,000 and more preferably between 10,000 and 100,000. Such vinylpyrrolidone/dialkylaminoalkyl acrylate or methacrylate copolymers are commercially available under the name copolymer 845®, Gafquat 734®, or Gafquat 755® from ISP Corporation, New York, N.Y. and Montreal, Canada or from BASF under the tradename Luviquat®.

Preferred vinylpyrrolidone/dialkylaminoalkyl acrylate or methacrylate copolymers are polyvinylpyrrolidone/dimethylaminoethylmethacrylate copolymer (PVP/DMAEM) commercially available from ISP under the product names Gafquat 755/N®.

Suitable polystyrenesulphonate polymers (PSS) for use herein for use herein are according to the formula:

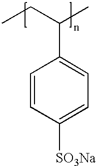

wherein n is an integer selected to give a molecular weight of the polymer of between 5000 and 10,000,000, and preferably of between 50,000 and 1,000,000.

Suitable polystyrenesulphonate polymers (PSS) for use herein are commercially available from National Starch (ICI) under the product names Aquatreat®) AR545, Aquatreat® AR546, Alcosperse® AS240 and Versaflex 7000®.

Suitable cetylhydroxethylcelluloses (HM-HEC) are hydroxyethylcelluloses hydrophobically modified with C₁₆ (cetyl) (Hexadecyl-2-hydroxyethylcellulose) according to the following formula:

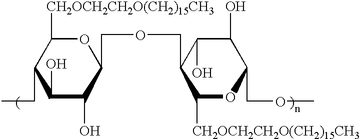

wherein n is greater than 1.

Suitable cetylhydroxethylcelluloses (HM-HEC) are commercially available from Aqualon/Hercules under the product name Polysurf 76®.

Suitable polyethyleneglycol bis(2-aminopropylethers) (DAP-PEG) are according to the formula:

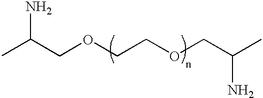

wherein n is an integer greater than 0.

Preferably n is an integer greater than 1, more preferably from 5 to 1000, even more preferably from 10 to 100, yet even more preferably from 20 to 60 and most preferably from 30 to 50.

A preferred polyethyleneglycol bis(2-aminopropylether) (DAP-PEG) is O,O′-bis(2-aminopropyl) polyethylene glycol having a molecular weight of 2000. Suitable polyethyleneglycol bis(2-aminopropylethers) (DAP-PEG) for use herein are commercially available from Huntsman under the product name Jeffamines® series.

Suitable polyvinylpyrrolidone vinylimidazole copolymers (PVP-VI) for use herein are according to the following formula

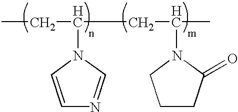

in which n is between 20 and 99, preferably between 55 and 90 mol % and more preferably between 60 and 90 mol %; and m is between 1 and 80, preferably between 10 and 45 mol %, and more preferably between 10 and 40 mol %.

The preferred polyvinylpyrrolidone vinylimidazole copolymers for use herein have a molecular weight of between 1,000 and 5,000,000, preferably between 5,000 and 2,000,000, more preferably between 5,000 and 500,000, and most preferably between 5,000 and 15,000.

Suitable polyvinylpyrrolidone vinylimidazole copolymers (PVP-VI) for use herein are commercially available from BASF under the tradename Luvitec® VPI 55 K18P and Luvitec® VPI 55 K72W series.

Suitable polyvinylpyrrolidone acrylic acid copolymers (PVP-AA) for use herein are according to the formula:

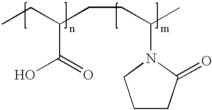

wherein n and m are integers selected to give a molecular weight of the polymer of between 1,000 and 1,000,000, preferably of between 10,000 and 500,000 and more preferably between 10,000 and 200,000.

Suitable polyvinylpyrrolidone acrylic acid copolymers (PVP-AA) for use herein are commercially available from BASF.

Suitable poly vinyl pyridine-N-oxide(PVNO) for use herein are according to the formula:

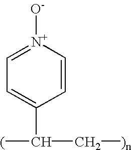

wherein n is an integer selected to give a molecular weight of the polymer of between 1,000 and 2,000,000, preferably of between 5,000 and 500,000, and more preferably between 15,000 and 50,000.

Suitable poly vinyl pyridine-N-oxide (PVNO) for use herein are available form Reilly industries and from Clariant/Hoechst (tradename HOE® S 4268).

Suitable polyacrylic polymers or acrylic-maleic copolymers for use herein are according to the general formula:

—(CH₂—CHCOOH)ₙ—(CHCOOH—CHCOOH)ₘ—

wherein n is an integer greater than 0, m is an integer of 0 (for polyacrylic polymers) or greater (for acrylic-maleic copolymers) and n and m are independently integers selected to give a molecular weight of the polymer of between 1,000 and 200,000, preferably of between 2,000 and 200,000, and more preferably between 3,000 and 100,000.

Suitable polyacrylic polymers or acrylic-maleic copolymers for use herein are available form BASF under the tradenames Sokalan® CP5 or CP7 or CP9.

Suitable polyacrylic phosphono end group polymers or acrylic-maleic phosphono end group copolymers for use herein are according to the general formula:

H₂P O₃—(CH₂—CHCOOH)ₙ—(CHCOOH—CHCOOH)ₘ—

wherein n is an integer greater than 0, m is an integer of 0 (for polyacrylic polymers) or greater (for acrylic-maleic copolymers) and n and m are integers independently selected to give a molecular weight of the polymer of between 500 and 200,000, preferably of between 500 and 100,000, and more preferably between 1,000 and 50,000. For polyacrylates, m is zero.

Suitable polyacrylic phosphono end group polymers or acrylic-maleic phosphono end group copolymers for use herein are available form Rohm &Haas under the tradenames Acusol® 420 or 470 or 425.

Preferably, said polymer as described herein is selected from the group consisting of: a vinylpyrrolidone homopolymer (PVP); a polyethyleneglycol dimethylether (DM-PEG); a vinylpyrrolidone/dialkylaminoalkyl acrylate or methacrylate copolymers; a polystyrenesulphonate polymer (PSS); a polyvinylpyrrolidone/polyacrylic acid copolymer (PVP-AA); and a poly acrylic-maleic co-polymer with a phosphonic end group; and mixtures thereof.

Typically, the liquid composition herein may comprise from 0.005% to 20%, preferably from 0.10% to 5.0%, more preferably from 0.1% to 3.0% and most preferably from 0.20% to 1.0% by weight of the total composition of said polymer.

It has been found that the presence of a specific polymer as described herein, when present, allows to further improve the grease removal performance of the liquid composition due to the specific sudsing/foaming characteristics they provide to said composition. Indeed, the inclusion of said polymers in a liquid composition provides a composition that forms a foam when said composition is applied, preferably sprayed, onto a surface. Said foam adheres to said surface and thereby improves the grease removal performance benefit of said liquid cleaning composition.

In addition, a grease removal performance benefit upon contact of the liquid composition on grease, without applying mechanical action, on inclined or vertical surfaces is provided by the process according to the present invention. Indeed, the adhesion as described above of the foam to surface allows said liquid composition to act on inclined or vertical surfaces without or at least reduced dripping or running off. Thus, a grease removal performance benefit upon contact of the liquid composition on grease, without applying mechanical action when said liquid composition is applied onto inclined or vertical surfaces is provided.

Furthermore, the sudsing/foaming properties of the liquid composition used in the process of cleaning a hard surface as described herein allows to formulate a sprayable liquid hard surface cleaning composition.

Optional Ingredients

Fatty Acid

The liquid compositions of the present invention may comprise fatty acid, or mixtures thereof as a highly preferred optional ingredient.

Suitable fatty acids for use herein are the alkali salts of a C₈-C₂₄ fatty acid. Such alkali salts include the metal fully saturated salts like sodium, potassium and/or lithium salts as well as the ammonium and/or alkylammonium salts of fatty acids, preferably the sodium salt. Preferred fatty acids for use herein contain from 8 to 22, preferably from 8 to 20 and more preferably from 8 to 18 carbon atoms.

Suitable fatty acids may be selected from caprylic acid, capric acid, lauric acid, myristic acid, palmitic acid, stearic acid, oleic acid, and mixtures of fatty acids suitably hardened, derived from natural sources such as plant or animal esters (e.g., palm oil, olive oil, coconut oil, soybean oil, castor oil, tallow, ground oil, whale and fish oils and/or babassu oil.

For example Coconut Fatty Acid is commercially available from UNICHEMA under the name PRIFAC 5900®.

Fatty acids are desired herein as they reduce the sudsing of the liquid composition used in the process according to the present invention when the composition is rinsed of the surface to which it has been applied before. Preferably, said fatty acids do not interfere with the sudsing/foaming properties provided to the liquid composition by the polymers as described herein.

Typically, the liquid composition herein may comprise up to 6%, preferably from 0.1% to 2.0%, more preferably from 0.1% to 1.0% and most preferably from 0.2% to 0.8% by weight of the total composition of said fatty acid.

Branched Fatty Alcohol

The liquid compositions of the present invention may comprise a branched fatty alcohol, or mixtures thereof as a highly preferred optional ingredient.

Suitable branched fatty alcohols to be used in the present invention are the 2-alkyl alkanols having an alkyl chain comprising from 6 to 16, preferably from 7 to 13, more preferably from 8 to 12, most preferably from 8 to 10 carbon atoms and a terminal hydroxy group, said alkyl chain being substituted in the α position (i.e., position number 2) by an alkyl chain comprising from 1 to 10, preferably from 2 to 8 and more preferably 4 to 6 carbon atoms.

Such suitable compounds are commercially available, for instance, as the Isofol® series such as Isofol® 12 (2-butyl octanol) or Isofol® 16 (2-hexyl decanol) commercially available from Condea.

Preferably said branched fatty alcohol is selected from the group consisting of 2-butyl octanol, 2-hexyl decanol, and a mixture thereof. More preferably said 2-alkyl alkanol is 2-butyl octanol.

Typically, the liquid composition herein may comprise up to 2%, preferably from 0.10% to 1.0%, more preferably from 0.1% to 0.8% and most preferably from 0.1% to 0.5% by weight of the total composition of said branched fatty alcohol.

Solvent

The liquid compositions of the present invention may comprise a solvent, or mixtures thereof as a highly preferred optional ingredient.

Suitable solvent is selected from the group consisting of: ethers and diethers having from 4 to 14 carbon atoms, preferably from 6 to 12 carbon atoms, and more preferably from 8 to 10 carbon atoms; glycols or alkoxylated glycols; alkoxylated aromatic alcohols; aromatic alcohols; alkoxylated aliphatic alcohols; aliphatic alcohols; C₈-C₁₄ alkyl and cycloalkyl hydrocarbons and halohydrocarbons; C₆-C₁ ₆ glycol ethers; terpenes; and mixtures thereof.

Suitable glycols to be used herein are according to the formula HO—CR₁ R₂—OH wherein R₁ and R₂ are independently H or a C₂—C₁₀ saturated or unsaturated aliphatic hydrocarbon chain and/or cyclic. Suitable glycols to be used herein are dodecaneglycol and/or propanediol.

Suitable alkoxylated glycols to be used herein are according to the formula R—(A)ₙ—R₁—OH wherein R is H, OH, a linear or branched, saturated or unsaturated alkyl of from 1 to 20 carbon atoms, preferably from 2 to 15 and more preferably from 2 to 10, wherein R₁ is H or a linear saturated or unsaturated alkyl of from 1 to 20 carbon atoms, preferably from 2 to 15 and more preferably from 2 to 10, and A is an alkoxy group preferably ethoxy, methoxy, and/or propoxy and n is from 1 to 5, preferably 1 to 2. Suitable alkoxylated glycols to be used herein are methoxy octadecanol and/or ethoxyethoxyethanol.

Suitable alkoxylated aromatic alcohols to be used herein are according to the formula R—(A)ₙ—OH wherein R is an alkyl substituted or non-alkyl substituted aryl group of from 1 to 20 carbon atoms, preferably from 2 to 15 and more preferably from 2 to 10, wherein A is an alkoxy group preferably butoxy, propoxy and/or ethoxy, and n is an integer of from 1 to 5, preferably 1 to 2. Suitable alkoxylated aromatic alcohols are benzoxyethanol and/or benzoxypropanol.

Suitable aromatic alcohols to be used herein are according to the formula R—OH wherein R is an alkyl substituted or non-alkyl substituted aryl group of from 1 to 20 carbon atoms, preferably from 1 to 15 and more preferably from 1 to 10. For example a suitable aromatic alcohol to be used herein is benzyl alcohol.

Suitable alkoxylated aliphatic alcohols to be used herein are according to the formula R—(A)ₙ—OH wherein R is a linear or branched, saturated or unsaturated alkyl group of from 1 to 20 carbon atoms, preferably from 2 to 15 and more preferably from 3 to 12, wherein A is an alkoxy group preferably butoxy, propoxy and/or ethoxy, and n is an integer of from 1 to 5, preferably 1 to 2. Suitable alkoxylated aliphatic linear or branched alcohols are butoxy propoxy propanol (n-BPP), butoxyethanol, butoxypropanol (n-BP), ethoxyethanol, 1-methylpropoxyethanol, 2-methylbutoxyethanol, or mixtures thereof. Butoxy propoxy propanol is commercially available under the trade name n-BPP® from Dow chemical. Butoxypropanol is commercially available from Dow chemical.

Suitable aliphatic alcohols to be used herein are according to the formula R—OH wherein R is a linear or branched, saturated or unsaturated alkyl group of from 1 to 20 carbon atoms, preferably from 2 to 15 and more preferably from 5 to 12. With the proviso that said aliphatic branched alcohols is not a 2-alkyl alkanol as described herein above. Suitable aliphatic alcohols are methanol, ethanol, propanol, isopropanol or mixtures thereof.

Suitable terpenes to be used herein monocyclic terpenes, dicyclic terpenes and/or acyclic terpenes. Suitable terpenes are D-limonene; pinene; pine oil; terpinene; terpene derivatives as menthol, terpineol, geraniol, thymol; and the citronella or citronellol types of ingredients.

Other suitable solvents include butyl diglycol ether (BDGE), hexandiols, butyltriglycol ether, ter amilic alcohol and the like. BDGE is commercially available from Union Carbide or from BASF under the trade name Butyl CARBITOL®.

Preferably said solvent is selected from the group consisting of butoxy propoxy propanol, butyl diglycol ether, benzyl alcohol, butoxypropanol, ethanol, methanol, isopropanol, hexandiols and mixtures thereof. More preferably said solvent is selected from the group consisting of butoxy propoxy propanol, butyl diglycol ether, benzyl alcohol, butoxypropanol, ethanol, methanol, isopropanol and mixtures thereof. Even more preferably said solvent is selected from the group consisting of butyl diglycol ether, butoxypropanol, ethanol and mixtures thereof.

Typically, the liquid composition herein may comprise up to 30%, preferably from 1% to 25%, more preferably from 1% to 20% and most preferably from 2% to 10% by weight of the total composition of said solvent or mixture thereof.

In a preferred embodiment the solvent comprised in the liquid composition according to the present invention is a volatile solvent or a mixture thereof, preferably a volatile solvent or a mixture thereof in combination with another solvent or a mixture thereof.

Perfumes

The liquid compositions of the present invention may comprise a perfume or a mixture thereof as a highly preferred optional ingredient.

Suitable perfumes for use herein include materials which provide an olfactory aesthetic benefit and/or cover any “chemical” odour that the product may have.

The main function of a small fraction of the highly volatile, low boiling (having low boiling points), perfume components in these perfumes is to improve the fragrance odour of the product itself, rather than impacting on the subsequent odour of the surface being cleaned. However, some of the less volatile, high boiling perfume ingredients provide a fresh and clean impression to the surfaces, and it is desirable that these ingredients be deposited and present on the dry surface. Perfume ingredients can be readily solubilized in the compositions, for instance by the nonionic detergent surfactants, when present. The perfume ingredients and compositions suitable to be used herein are the conventional ones known in the art. Selection of any perfume component, or amount of perfume, is based solely on aesthetic considerations.

Suitable perfume compounds and compositions can be found in the art including U.S. Pat. Nos. 4,145,184, Brain and Cummins, issued Mar. 20, 1979; U.S. Pat. No. 4,209,417, Whyte, issued Jun. 24, 1980; U.S. Pat. No. 4,515,705, Moeddel, issued May 7, 1985; and U.S. Pat. No. 4,152,272, Young, issued May 1, 1979, all of said Patents being incorporated herein by reference. In general, the degree of substantivity of a perfume is roughly proportional to the percentages of substantive perfume material used. Relatively substantive perfumes contain at least about 1%, preferably at least about 10%, substantive perfume materials. Substantive perfume materials are those odorous compounds that deposit on surfaces via the cleaning process and are detectable by people with normal olfactory acuity. Such materials typically have vapour pressures lower than that of the average perfume material. Also, they typically have molecular weights of about 200 and above, and are detectable at levels below those of the average perfume material. Perfume ingredients useful herein, along with their odour character, and their physical and chemical properties, such as boiling point and molecular weight, are given in “Perfume and Flavor Chemicals (Aroma Chemicals),” Steffen Arctander, published by the author, 1969, incorporated herein by reference.

Examples of the highly volatile, low boiling, perfume ingredients are: anethole, benzaldehyde, benzyl acetate, benzyl alcohol, benzyl formate, iso-bornyl acetate, camphene, ciscitral (neral), citronellal, citronellol, citronellyl acetate, para-cymene, decanal, dihydrolinalool, dihydromyrcenol, dimethyl phenyl carbinol, eucaliptol, geranial, geraniol, geranyl acetate, geranyl nitrile, cis-3-hexenyl acetate, hydroxycitronellal, d-limonene, linalool, linalool oxide, linalyl acetate, linalyl propionate, methyl anthranilate, alpha-methyl ionone, methyl nonyl acetaldehyde, methyl phenyl carbinyl acetate, laevo-menthyl acetate, menthone, iso-menthone, mycrene, myrcenyl acetate, myrcenol, nerol, neryl acetate, nonyl acetate, phenyl ethyl alcohol, alpha-pinene, beta-pinene, gamma-terpinene, alpha-terpineol, beta-terpineol, terpinyl acetate, and vertenex (para-tertiary-butyl cyclohexyl acetate). Some natural oils also contain large percentages of highly volatile perfume ingredients. For example, lavandin contains as major components: linalool; linalyl acetate; geraniol; and citronellol. Lemon oil and orange terpenes both contain about 95% of d-limonene.

Examples of moderately volatile perfume ingredients are: amyl cinnamic aldehyde, iso-amyl salicylate, beta-caryophyllene, cedrene, cinnamic alcohol, coumarin, dimethyl benzyl carbinyl acetate, ethyl vanillin, eugenol, iso-eugenol, flor acetate, heliotropine, 3-cis-hexenyl salicylate, hexyl salicylate, lilial (para-tertiarybutyl-alpha-methyl hydrocinnamic aldehyde), gamma-methyl ionone, nerolidol, patchouli alcohol, phenyl hexanol, beta-selinene, trichloromethyl phenyl carbinyl acetate, triethyl citrate, vanillin, and veratraldehyde. Cedarwood terpenes are composed mainly of alpha-cedrene, beta-cedrene, and other C15H24 sesquiterpenes.

Examples of the less volatile, high boiling, perfume ingredients are benzophenone, benzyl salicylate, ethylene brassylate, galaxolide (1,3,4,6,7,8-hexahydro-4,6,6,7,8,8-hexamethyl-cyclopenta-gama-2-benzopyran), hexyl cinnamic aldehyde, lyral (4-(4-hydroxy-4-methyl pentyl)-3-cyclohexene-10-carboxaldehyde), methyl cedrylone, methyl dihydro jasmonate, methyl-beta-naphthyl ketone, musk indanone, musk ketone, musk tibetene, and phenylethyl phenyl acetate.

Selection of any particular perfume ingredient is primarily dictated by aesthetic considerations.

The compositions herein may comprise a perfume or a mixture thereof, in amounts up to 5.0%, preferably in amounts of 0.01% to 2.0%, more preferably in amounts of 0.05% to 1.5%, even more preferably in amounts of 0.1% to 1.0%, by weight of the total composition.

Other Optional Ingredients:

The liquid compositions according to the present invention may comprise a variety of other optional ingredients depending on the technical benefit aimed for and the surface treated.

Suitable optional ingredients for use herein include surfactants, builders, chelants, polymers, buffers, bactericides, hydrotropes, colorants, stabilisers, radical scavengers, bleaches, bleach activators, enzymes, soil suspenders, dye transfer agents, brighteners, anti dusting agents, dispersants, dye transfer inhibitors, pigments, silicones and/or dyes.

Chelating Agents

One class of optional compounds for use herein includes chelating agents or mixtures thereof. Chelating agents can be incorporated in the compositions herein in amounts ranging from 0.0% to 10.0% by weight of the total composition, preferably 0.1% to 5.0%.

Suitable phosphonate chelating agents for use herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins. Ethylenediamine N,N′-disuccinic acids is, for instance, commercially available under the tradename ssEDDS® from Palmer Research Laboratories.

Suitable amino carboxylates for use herein include ethylene diamine tetra acetates, diethylene triamine pentaacetates, diethylene triamine pentaacetate (DTPA),N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA).

Further carboxylate chelating agents for use herein include salicylic acid, aspartic acid, glutamic acid, glycine, malonic acid or mixtures thereof.

Builders

The liquid compositions of the present invention may also comprise a builder or a mixture thereof, as an optional ingredient. Suitable builders for use herein include polycarboxylates and polyphosphates, and salts thereof. Typically, the compositions of the present invention comprise up to 20.0% by weight of the total composition of a builder or mixtures thereof, preferably from 0.1% to 10.0% , and more preferably from 0.5% to 5.0%.

Such suitable and preferred polycarboxylates include citrate and complexes of the formula:

CH(A)(COOX)—CH(COOX)—O—CH(COOX)—CH(COOX)(B)

wherein A is H or OH; B is H or —O—CH(COOX)—CH₂(COOX); and X is H or a salt-forming cation. For example, if in the above general formula A and B are both H, then the compound is oxydisuccinic acid and its water-soluble salts. If A is OH and B is H, then the compound is tartrate monosuccinic acid (TMS) and its water-soluble salts. If A is H and B is —O—CH(COOX)—CH₂(COOX), then the compound is tartrate disuccinic acid (TDS) and its water-soluble salts. Mixtures of these builders are especially preferred for use herein. Particularly TMS to TDS, these builders are disclosed in U.S. Pat. No. 4,663,071, issued to Bush et al., on May 5, 1987.

Still other ether polycarboxylates suitable for use herein include copolymers of maleic anhydride with ethylene or vinyl methyl ether, 1, 3, 5-trihydroxy benzene-2, 4, 6-trisulfonic acid.

Other useful polycarboxylate builders include the ether hydroxypolycarboxylates represented by the structure:

HO—[C(R) (COOM)—C(R)(COOM)—O]ₙ—H

wherein M is hydrogen or a cation wherein the resultant salt is water-soluble, preferably an alkali metal, ammonium or substituted ammonium cation, n is from about 2 to about 15 (preferably n is from about 2 to about 10, more preferably n averages from about 2 to about 4) and each R is the same or different and selected from hydrogen, C₁₋₄ alkyl or C₁₋₄ substituted alkyl (preferably R is hydrogen).

Suitable ether polycarboxylates also include cyclic compounds, particularly alicyclic compounds, such as those described in U.S. Pat. Nos. 3,923,679; 3,835,163; 4,158,635; 4,120,874 and 4,102,903, all of which are incorporated herein by reference.

Preferred amongst those cyclic compounds are dipicolinic acid and chelidanic acid.

Also suitable polycarboxylates for use herein are mellitic acid, succinic acid, polymaleic acid, benzene 1,3,5-tricarboxylic acid, benzene pentacarboxylic acid, and carboxymethyloxysuccinic acid, and soluble salts thereof.

Still suitable carboxylate builders herein include the carboxylated carbohydrates disclosed in U.S. Pat. No. 3,723,322, Diehl, issued Mar. 28, 1973, incorporated herein by reference.

Other suitable carboxylates for use herein, but which are less preferred because they do not meet the above criteria are alkali metal, ammonium and substituted ammonium salts of polyacetic acids. Examples of polyacetic acid builder salts are sodium, potassium, lithium, ammonium and substituted ammonium salts of ethylenediamine, tetraacetic acid and nitrilotriacetic acid.

Other suitable, but less preferred polycarboxylates are those also known as alkyliminoacetic builders such as methyl imino diacetic acid, alanine diacetic acid, methyl glycine diacetic acid, hydroxy propylene imino diacetic acid and other alkyl imino acetic acid builders.

Also suitable in the compositions of the present invention are the 3,3-dicarboxy-4-oxa-1,6-hexanediotes and the related compounds disclosed in U.S. Pat. No. 4,566,984, Bush, issued Jan. 28, 1986, incorporated herein by reference. Useful succinic acid builders (succinate builders) include the C5-C20 alkyl succinic acids and salts thereof. A particularly preferred compound of this type is dodecenylsuccinic acid. Alkyl succinic acids typically are of the general formula R—CH(COOH)CH₂(COOH) i.e., derivatives of succinic acid, wherein R is hydrocarbon, e.g., C₁₀-C₂₀ alkyl or alkenyl, preferably C₁₂-C₁₆ or wherein R may be substituted with hydroxyl, sulfo, sulfoxy or sulfone substituents, all as described in the above-mentioned Patents.

Other suitable succinate builders include imino disuccinate, oxodisuccinates, tartrate monosuccinate, tartratedisuccinates and polysuccinates.

The succinate builders are preferably used in the form of their water-soluble salts, including the sodium, potassium, ammonium and alkanolammonium salts.

Specific examples of succinate builders include: laurylsuccinate, myristylsuccinate, palmitylsuccinate, 2-dodecenylsuccinate (preferred), 2-pentadecenylsuccinate, and the like. Laurylsuccinates are the preferred builders of this group, and are described in European Patent Application 86200690.5/0 200 263, published Nov. 5, 1986.

Examples of useful builders also include sodium and potassium carboxymethyloxymalonate, carboxymethyloxysuccinate, cis-cyclo-hexanehexacarboxylate, cis-cyclopentane-tetracarboxylate, water-soluble polyacrylates and the copolymers of maleic anhydride with vinyl methyl ether or ethylene.

Other suitable polycarboxylates are the polyacetal carboxylates disclosed in U.S. Pat. No. 4,144,226, Crutchfield et al., issued Mar. 13, 1979, incorporated herein by reference. These polyacetal carboxylates can be prepared by bringing together, under polymerisation conditions, an ester of glyoxylic acid and a polymerisation initiator. The resulting polyacetal carboxylate ester is then attached to chemically stable end groups to stabilise the polyacetal carboxylate against rapid depolymerization in alkaline solution, converted to the corresponding salt, and added to a surfactant.

Polycarboxylate builders are also disclosed in U.S. Pat. No. 3,308,067, Diehl, issued Mar. 7, 1967, incorporated herein by reference. Such materials include the water-soluble salts of homo- and copolymers of aliphatic carboxylic acids such as maleic acid, itaconic acid, mesaconic acid, fumaric acid, aconitic acid, citraconic acid and methylenemalonic acid.

Suitable polyphosphonates for use herein are the alkali metal, ammonium and alkanolammonium salts of polyphosphates (exemplified by the tripolyphosphates, pyrophosphates, and glassy polymeric meta-phosphates), phosphonates. The most preferred builder for use herein is citrate.

Surfactants

The liquid compositions of the present invention may comprise an additional surfactant, or mixtures thereof as an optional ingredient on top of the surfactants described herein above.

Said additional surfactant may be present in the compositions according to the present invention in amounts of from 0.01% to 50%, preferably of from 0.1% to 20%, and more preferably of from 0.5% to 1% by weight of the total composition.

Surfactants are desired herein as they further contribute to the cleaning performance benefit of the liquid compositions of the present invention and/or provide a gloss benefit to the liquid composition of the present invention.

Divalent Ions

The compositions according to the present invention may further comprise a divalent ion, or mixtures thereof. All divalent ions known to those skilled in the art may be used herein. Preferred divalent ions to be used herein are calcium, zinc, cadmium, nickel, copper, cobalt, zirconium, chromium and/or magnesium and more preferred are calcium, zinc and/or magnesium. Said divalent ions may be added in the form of salts for example as chloride, acetate, sulphate, formate and/or nitrate or as a complex metal salt. For example, calcium may be added in the form of calcium chloride, magnesium as magnesium acetate or magnesium sulphate and zinc as zinc chloride. Typically such ions may be present at a level up to 3%, preferably from 0.001% to 1% by weight of the total composition.

Bleaching Components

The liquid compositions herein may also comprise a bleaching component. Any bleach known to those skilled in the art may be suitable to be used herein including any peroxygen bleach as well as a chlorine releasing component.

Suitable peroxygen bleaches for use herein include hydrogen peroxide or sources thereof. As used herein a source of hydrogen peroxide refers to any compound which produces active oxygen when said compound is in contact of water. Suitable water-soluble sources of hydrogen peroxide for use herein include percarbonates, preformed percarboxylic acids, persilicates, persulphates, perborates, organic and inorganic peroxides and/or hydroperoxides.

Suitable chlorine releasing component for use herein is an alkali metal hypochlorite. Advantageously, the compositions of the invention are stable in presence of this bleaching component. Although alkali metal hypochlorites are preferred, other hypochlorite compounds may also be used herein and can be selected from calcium and magnesium hypochlorite. A preferred alkali metal hypochlorite for use herein is sodium hypochlorite.

Bleach Activators

The compositions of the present invention that comprise a peroxygen bleach may further comprise a bleach activator or mixtures thereof. By “bleach activator”, it is meant herein a compound which reacts with peroxygen bleach like hydrogen peroxide to form a peracid. The peracid thus formed constitutes the activated bleach. Suitable bleach activators to be used herein include those belonging to the class of esters, amides, imides, or anhydrides. Examples of suitable compounds of this type are disclosed in British Patent GB 1 586 769 and GB 2 143 231 and a method for their formation into a prilled form is described in European Published Patent Application EP-A-62 523. Suitable examples of such compounds to be used herein are tetracetyl ethylene diamine (TAED), sodium 3,5,5 trimethyl hexanoyloxybenzene sulphonate, diperoxy dodecanoic acid as described for instance in U.S. Pat. No. 4,818,425 and nonylamide of peroxyadipic acid as described for instance in U.S. Pat. No. 4,259,201 and n-nonanoyloxybenzenesulphonate (NOBS). Also suitable are N-acyl caprolactams selected from the group consisting of substituted or unsubstituted benzoyl caprolactam, octanoyl caprolactam, nonanoyl caprolactam, hexanoyl caprolactam, decanoyl caprolactam, undecenoyl caprolactam, formyl caprolactam, acetyl caprolactam, propanoyl caprolactam, butanoyl caprolactam pentanoyl caprolactam or mixtures thereof. A particular family of bleach activators of interest was disclosed in EP 624 154, and particularly preferred in that family is acetyl triethyl citrate (ATC). Acetyl triethyl citrate has the advantage that it is environmental-friendly as it eventually degrades into citric acid and alcohol. Furthermore, acetyl triethyl citrate has a good hydrolytical stability in the product upon storage and it is an efficient bleach activator. Finally, it provides good building capacity to the composition.

Packaging Form of the Compositions

The compositions herein may be packaged in a variety of suitable detergent packaging known to those skilled in the art. Preferably, the liquid compositions are packaged in conventional detergent plastic bottles.

In one embodiment the compositions herein may be packaged in manually or electrically operated spray dispensing containers, which are usually made of synthetic organic polymeric plastic materials. Accordingly, the present invention also encompasses liquid hard surface cleaning compositions of the invention packaged in a spray dispenser, preferably in a trigger spray dispenser or pump spray dispenser.

Indeed, said spray-type dispensers allow to uniformly apply to a relatively large area of a surface to be cleaned the liquid cleaning compositions suitable for use according to the present invention. Such spray-type dispensers are particularly suitable to clean inclined or vertical surfaces.

Suitable spray-type dispensers to be used according to the present invention include manually operated foam trigger-type dispensers sold for example by Speciality Packaging Products, Inc. or Continental Sprayers, Inc. These types of dispensers are disclosed, for instance, in U.S. Pat. No. 4,701,311 to Dunnining et al. and U.S. Pat. No. 4,646,973 and U.S. Pat. No. 4,538,745 both to Focarracci. Particularly preferred to be used herein are spray-type dispensers such as T 8500® commercially available from Continental Spray International or T 8100® commercially available from Canyon, Northern Ireland. In such a dispenser the liquid composition is divided in fine liquid droplets resulting in a spray that is directed onto the surface to be treated. Indeed, in such a spray-type dispenser the composition contained in the body of said dispenser is directed through the spray-type dispenser head via energy communicated to a pumping mechanism by the user as said user activates said pumping mechanism. More particularly, in said spray-type dispenser head the composition is forced against an obstacle, e.g. a grid or a cone or the like, thereby providing shocks to help atomise the liquid composition, i.e. to help the formation of liquid droplets.

### EXAMPLES

The following examples will further illustrate the present invention. The compositions are made by combining the listed ingredients in the listed proportions (weight % unless otherwise specified). The following Examples are meant to exemplify compositions used in a process according to the present invention but are not necessarily used to limit or otherwise define the scope of the present invention.

| | A | B | C | D | E | F | G | H | I |
|---|---|---|---|---|---|---|---|---|---|
| Alkoxylated | | | | | | | | | |
| nonionic | | | | | | | | | |
| surfactants | | | | | | | | | |
| C 9-11 EO5 | 0.35 | — | 0.3 | 2.0 | — | — | 1.7 | — | — |
| C12,14 EO5 | — | — | — | — | 1.7 | — | — | — | — |
| C11 EO5 | — | 0.7 | — | — | — | 3.7 | — | 0.5 | 3.0 |
| C12,14 EO21 | 0.35 | — | — | 2.0 | 2.0 | — | 1.7 | 0.2 | 1.5 |
| Anionic | | | | | | | | | |
| surfactants | | | | | | | | | |
| NaPS | 0.31 | 0.3 | 0.4 | 2.0 | 1.7 | — | 1.0 | 0.31 | 1.0 |
| NaLAS | — | — | — | — | — | 1.7 | — | — | 1.0 |
| NaCS | — | — | — | 2.0 | 1.0 | 1.5 | 1.5 | — | 2.0 |
| Isalchem ® AS | — | — | — | — | — | — | 1.0 | — | — |
| Neutralising co- | | | | | | | | | |
| surtactants | | | | | | | | | |
| C12-14 AO | 0.39 | 0.4 | 0.5 | 2.6 | 2.2 | 2.6 | 1.5 | — | 2.0 |
| C12-14 Betaine | — | — | — | — | — | — | 1.5 | 0.4 | 1.0 |
| Polymers | | | | | | | | | |
| PSS | 0.5 | 0.5 | — | — | — | — | 0.3 | 0.3 | — |
| DMPEG | — | — | 0.25 | 0.25 | 0.5 | 0.25 | — | — | — |
| PVP K90 ® | — | — | 0.25 | 0.25 | 0.5 | — | 0.3 | — | — |
| PVP-DMAEM | — | — | — | — | — | 0.25 | — | — | 0.25 |
| HM-HEC | — | — | — | 0.30 | — | 0.20 | — | — | 0.3 |
| Buffer | | | | | | | | | |
| Na₂CO₃ | 0.10 | 0.20 | 0.10 | 0.30 | 0.10 | 0.20 | 0.20 | 0.10 | 0.3 |
| Citric | 0.75 | 0.65 | 0.70 | 0.75 | 1.0 | 0.70 | 0.75 | 0.50 | 0.75 |
| Caustic | 0.50 | 0.45 | 0.48 | 0.50 | 0.75 | 0.5 | 0.5 | 0.35 | 0.50 |
| Suds control | | | | | | | | | |
| Fatty Acid | 0.20 | 0.2 | — | 0.40 | 0.50 | 0.50 | 0.40 | 0.30 | 0.5 |
| Branched fatty | | | | | | | | | |
| alcohol | | | | | | | | | |
| Isofol 12 ® | 0.20 | — | 0.15 | 0.30 | — | 0.3 | — | — | 0.3 |
| Isofol 16 ® | — | 0.2 | — | — | 0.3 | — | 0.30 | 0.20 | — |
| Solvents | | | | | | | | | |
| EtOH | — | — | 3.0 | — | 1.0 | — | — | — | — |
| n-BP | 4.0 | 3.0 | 2.0 | — | — | — | — | 3.0 | 2.0 |
| BDGE | — | — | 1.0 | — | 3.0 | — | 1.5 | — | — |
| IPA | — | 3.0 | — | — | — | — | — | 3.0 | — |
| n-BPP | — | — | — | 3.0 | — | 2.0 | 1.5 | — | 2.0 |
| Limonene | | — | — | — | — | — | — | — | — |
| Minors and | — | — | up | to | 100 | % | — | — | — |
| water | | | | | | | | | |
| pH | 9.5 | 9.5 | 9.0 | 9.7 | 8.6 | 9.0 | 9.0 | 8.3 | 9.0 |
| Alkoxylated | | | | | | | | | |
| nonionic | | | | | | | | | |
| surfactants | | | | | | | | | |
| C 9-11 EO5 | 0.35 | | | | | | | | |
| C12,14 EO5 | — | | | | | | | | |
| C11 EO5 | — | | | | | | | | |
| C12,14 EO21 | 0.35 | | | | | | | | |
| Anionic | | | | | | | | | |
| surfactants | | | | | | | | | |
| NaPS | 0.31 | | | | | | | | |
| NaLAS | — | | | | | | | | |
| NaCS | — | | | | | | | | |
| Isalchem ® AS | — | | | | | | | | |
| C8SO3 | — | | | | | | | | |
| C7-9SO4 | — | | | | | | | | |
| Neutralising co- | | | | | | | | | |
| surfactants | | | | | | | | | |
| C12-14 AO | 0.40 | | | | | | | | |
| C12-14 Betaine | — | | | | | | | | |
| Sulphobetaine | | | | | | | | | |
| Polymers | | | | | | | | | |
| PSS | — | | | | | | | | |
| DMPEG | — | | | | | | | | |
| PVP K90 ® | — | | | | | | | | |
| PVP-DMAEM | — | | | | | | | | |
| HM-HEC | — | | | | | | | | |
| Acusol 425N ® | 1.0 | | | | | | | | |
| Buffer | | | | | | | | | |
| Na₂CO₃ | 0.10 | | | | | | | | |
| Citric | — | | | | | | | | |
| Lactic | | | | | | | | | |
| Caustic | 0.10 | | | | | | | | |
| NaCl | — | | | | | | | | |
| H2SO4 | — | | | | | | | | |
| Suds control | | | | | | | | | |
| Fatty Acid | 0.20 | | | | | | | | |
| Branched fatty | | | | | | | | | |
| alcohol | | | | | | | | | |
| Isofol 12 ® | 0.20 | | | | | | | | |
| Isofol 16 ® | — | | | | | | | | |
| Solvents | | | | | | | | | |
| EtOH | — | | | | | | | | |
| n-BP | 4.0 | | | | | | | | |
| BDGE | — | | | | | | | | |
| IPA | 1.0 | | | | | | | | |
| n-BPP | — | | | | | | | | |
| Limonene | | | | | | | | | |
| Minors and | — | | | | | | | | |
| water | | | | | | | | | |
| pH | 9.5 | | | | | | | | |

C 9-11 EO5 is a C 9-11 EO5 nonionic surfactant commercially available from ICI or Shell.

C12,14 EO5 is a C12, 14 EO5 nonionic surfactant commercially available from Huls, A&W or Hoechst.

C11 EO5 is a C11 EO5 nonionic surfactant.

C12,14 EO21 is a C12-14 EO21 nonionic surfactant.

NaPS is Sodium Paraffin sulphonate commercially available from Huls or Hoechst.

NaLAS is Sodium Linear Alkylbenzene sulphonate commercially available from A&W.

NaCS is Sodium Cumene sulphonate commercially available from A&W.

Isalchem® AS is a C₁₂₋₁₃ sulphate surfactant commercially available from Enichem.

C12-14 AO is a C12-14 amine oxide surfactant.

C12-14 Betaine is a C12-14 betaine surfactant.

Sulphobetaine is a C12,14 sulphobetaine commercially available from Witco (Rewoteric AM-CAS®).

C8SO3 is Octylsulphonate commercially available from Witco (Witconate NAS-8®).

C7-9SO4 is C7-9 sulphate.

PSS is a polystyrenesulphonate polymer.

DMPEG is a polyethyleneglycol dimethylether.

PVP K90® is a vinylpyrrolidone homopolymer commercially available from ISP Corp.

PVP-DMAEM is a polyvinylpyrrolidone/dimethylaminoethylmethacrylate copolymer.

HM-HEC is a cetylhydroxethylcellulose.

Isofol 12® is 2-butyl octanol commercially available from Condea.

Isofol 16® is 2-hexyl decanol commercially available from Condea.

n-BP is normal butoxy propanol commercially available from Dow Chemicals.

BDGE is normal buthyl diglycolether commercially available from Union Carbide or BASF.

Ethanol is commercially available from Condea.

IPA is isopropanol.

n-BPP is butoxy propoxy propanol available from Dow Chemicals.

Acusol 425N® is a acrylic-maleic (ratio 80/20) phosphono end group copolymers for use herein are available form Rohm &Haas

These liquid compositions are used in a process as disclosed herein and provide a grease and a greasy particulate soil removal performance benefit and/or a grease and a greasy particulate soil removal performance benefit upon contact of the liquid composition on grease, without applying mechanical action, on horizontal, inclined and vertical surfaces.

What is claimed is:

1. A process of cleaning a hard surface with a liquid neutral to alkaline composition comprising:
a polymer selected from the group consisting of: a vinylpyrrolidone homopolymer (PVP); a polyethyleneglycol dimethylether (DM-PEG); a vinylpyrrolidone/dialkylaminoalkyl acrylate or methacrylate copolymers; a polystyrenesulphonate polymer (PSS); a poly vinyl pyridine-N-oxide (PVNO); a polyethyleneglycol bis(2-aminopropylether) (DAP-PEG); a polyvinylpyrrolidone/vinylimidazole copolymer (PVP-VI); a cetylhydroxethylcellulose (HM-HEC); a polyvinylpyrrolidone/polyacrylic acid copolymer (PVP-AA); a polyvinylpyrrolidone/vinylacetate copolymer (PVP-VA); a polyacrylic polymer or a poly acrylic-maleic co-polymer; a polyacrylic polymer or a poly acrylic-maleic co-polymer with a phosphonic end group;
and mixtures thereof; and
a surfactant system comprising:
a sulphated or sulphonated anionic surfactant;
a neutralizing co surfactant; and
an alkoxylated non ionic surfactant.

2. A process according to claim 1 wherein said liquid composition is sprayed onto said hard surface.

3. A process according to claim 1 wherein said hard surface is inclined or vertical.

4. A process according to claim 1 wherein said hard surface is a ceramic surface, enamel surface, stainless steel surface, chromed surface or Formica® surface.

5. A process according to claim 1 wherein said sulphated or sulphonated anionic surfactant is selected from the group consisting of: alkyl sulphates; alkyl aryl sulphates; alkyl alkoxylated sulphates; alkyl sulphonates; alkyl aryl sulphonates; alkyl alkoxylated sulphonates; C₆-C₂₀ alkyl alkoxylated linear or branched diphenyl oxide disulphonates; naphthalene sulphonates; and mixtures thereof.

6. A process according to claim 1 wherein said liquid composition comprises from 0.005% to 20% by weight of the total composition of said sulphated or sulphonated anionic surfactant.

7. A process according to claim 1 wherein said neutralising co-surfactant is uncharged or comprises positive and negative charges within the same molecule.

8. A process according to claim 1 wherein said liquid composition comprises from 0.005% to 30% by weight of the total composition of said neutralising co-surfactant.

9. A process according to claim 1 wherein said alkoxylated nonionic surfactant is selected from the group consisting of: non-capped alkoxylated nonionic surfactants; and capped alkoxylated nonionic surfactants; and mixtures thereof.

10. A process according to claim 1 wherein said liquid composition comprises from 0.005% to 30% by weight of the total composition of said alkoxylated nonionic surfactant.

11. A process according to claim 1 wherein said liquid composition comprises from 0.005% to 20% by weight of the total composition of said polymer.

12. A process according to claim 1 wherein said liquid composition further comprises a fatty acid or a mixture thereof.

13. A process according to claim 12 wherein said liquid composition comprises up to 2% by weight of the total composition of said fatty acid.

14. A process according to claim 1 wherein said liquid composition further comprises a solvent or a mixture thereof.

15. A process according to claim 1 wherein said liquid composition further comprises a builder or a mixture thereof.
